(19) United States
(12) Patent Application Publication
(10) Pub. No.: US 2005/0123719 A1
(43) Pub. Date: Jun. 9, 2005

(54) Method and system for forming a printed identification card

(75) Inventors: Gary M. Klinefelter, Eden Prairie, MN (US); Max C. Peters, Minnetonka, MN (US); Leon Gershenovich, Eden Prairie, MN (US); Karl A. Karst, Woodbury, MN (US); Ted M. Hoffman, Eden Prairie, MN (US); Martin A. Pribula, Eden Prairie, MN (US)

Correspondence Address: Leanne R. Taveggia;Westman, Champlin & Kelly, Suite 1600, 900 Second Avenue South, Minneapolis, MN, 55402-3319, US

(73) Assignee: Fargo Electronics, Inc., Eden Prairie, MN (US)

(21) Appl. No.: 11/004,549

(22) Filed: Dec. 3, 2004

Related U.S. Application Data
(60) Provisional application No. 60/526,632, filed on Dec. 3, 2003.

(51) Int. Cl. B32B 3/10

(52) U.S. Cl. 428/131; 156/384; 156/217

(57) ABSTRACT

Methods and systems are described for forming identification cards. The methods and systems incorporate a patch laminate transport for transporting a patch laminate along a patch laminate path and a card transport for transporting a card substrate along a card path. The patch laminate path and card path are substantially perpendicular to each other and intersect at an intersecting junction. A middle portion of the patch laminate is aligned with the intersecting junction. An intersecting edge of the card substrate is driven into the middle portion. A lamination mechanism laminates a first laminate portion to a first face and a second laminate portion to a second face of the card substrate.

The present application is based on and claims the benefit of U.S. provisional patent application Ser. No. 60/526,632, filed Dec. 3, 2003, the content of which is hereby incorporated by reference in its entirety.

### FIELD OF THE INVENTION

The present invention relates to devices for forming identification cards. More particularly, the present invention relates to a device for attaching thin films to card substrates.

### BACKGROUND OF THE INVENTION

Identification cards, along with the aid of a computer, are typically formed by printing an image on a card substrate and laminating a protective layer over the printed surface. The image generally includes a photograph and other information relating to the cardholder, such as the cardholder's name, employee number, and other information. The image that is to be printed by an identification card printer is generally formed by combining textual and graphical portions received from host applications running on the computer or from other input devices such as keyboards, scanners, and digital cameras.

Typical components used to form an identification card include a print mechanism, a transport mechanism, and a lamination mechanism. Example print mechanisms include a thermal printhead having a thermal print ribbon and an ink jet printhead having a supply of ink. The transport mechanism is generally configured to transport cards to the print mechanism for printing and to transport cards to the lamination mechanism for laminating a protective layer onto the card. The protective layer can be an individual laminate sheet received from a web or a roll of laminate material. The lamination mechanism generally includes a lamination roller for laminating the laminate sheet onto one side of the card substrate.

Current devices form dual-sided identification cards by utilizing many steps. A transport mechanism transports cards to a print mechanism for printing a first side of the card substrate. The transport mechanism also transports cards to a lamination mechanism for laminating a protective layer onto the first side of the card substrate. Following the printing and laminating steps on the first side of the card substrate, a card flipper mechanism flips the card substrate. The card is fed back to the print mechanism and lamination mechanism to repeat the above process on the second side of the card substrate.

Such a device for forming a dual-sided identification card leads to a time consuming process and inefficient card production. A device that has complicated moving components, such as the flipper, and complicated processes can lead to errors, which further decreases card producing efficiency.

### SUMMARY OF THE INVENTION

The present invention includes a method and system for forming an identification card. In one embodiment, the system includes a patch laminate transport mechanism configured to transport a patch laminate along a patch laminate path. A card transport mechanism is configured to transport a card substrate along a card path. The card path is substantially perpendicular to the patch laminate path and the patch laminate path intersects the card path at an intersecting junction. A controller is configured to align a middle portion of the patch laminate with the intersecting junction. A lamination mechanism is configured to laminate a first laminate portion of the patch laminate to a first face of the card substrate and a second laminate portion of the patch laminate to a second face of the card substrate.

In another embodiment, the method for forming an identification card includes transporting a patch laminate along a patch laminate path to an intersecting junction of the patch laminate path and a card path. The patch laminate path is substantially perpendicular to the card path. The method also includes aligning a middle portion of the patch laminate with the intersecting junction. An intersecting edge of the card substrate is driven along the card path into the middle portion of the patch laminate at the intersecting junction. The patch laminate is folded about the card substrate such that a first laminate portion overlays a first face of the card substrate and a second laminate portion overlays a second face of the card substrate. The second face is opposite the first face.

In yet another embodiment, the patch laminate includes a first laminate portion including an adhesive layer having a shape that conforms to a first face of the card substrate. The patch laminate includes a second laminate portion including an adhesive layer having a shape that conforms to a second face of the card substrate. The patch laminate also includes a bridge portion or middle portion connecting the first laminate portion at a first edge and the second laminate portion at a second edge. The first and second edges are displaced from each other by a distance corresponding to a thickness of the card substrate.

In yet another embodiment, the present invention includes a method of feeding patch laminate sheets. The method includes providing a patch laminate feeder including a housing containing a platform that supports a stack of patch laminate sheets and a feed roller. The platform is raised to force a top patch laminate sheet of the stack of patch laminate sheets against the feed roller. The platform is lowered after the feeder roller engages the top patch laminate sheet. The top patch laminate sheet is driven through a gap in the housing after the lowering of the platform.

### BRIEF DESCRIPTION OF THE DRAWINGS

FIG. 1 illustrates a schematic diagram of a device for forming an identification card in accordance with embodiments of the present invention.

FIG. 2 illustrates a schematic diagram of a device for forming an identification card in accordance with embodiments of the present invention.

FIG. 3 illustrates a top plan view of a patch laminate in accordance with embodiments of the present invention.

FIG. 4 illustrates a top plan view of a patch laminate in accordance with embodiments of the present invention.

FIG. 5 illustrates a top plan view of a patch laminate in accordance with embodiments of the present invention.

FIG. 6 illustrates a top plan view of a patch laminate in accordance with embodiments of the present invention.

FIG. 7 illustrates a sectional view of a patch laminate in accordance with embodiments of the present invention.

FIG. 8 illustrates a sectional view of a patch laminate in accordance with embodiments of the present invention.

FIG. 9 illustrates an exploded perspective view of a feeder cartridge in accordance with embodiments of the present invention.

FIG. 10 illustrates a top perspective view of a feeder cartridge in accordance with embodiments of the present invention.

FIG. 11 illustrates a side view of a feeder cartridge portion and an intersecting junction portion in accordance with embodiments of the present invention.

FIG. 12 illustrates a side view of a feeder cartridge portion and an intersecting junction portion in accordance with embodiments of the present invention.

FIG. 13 illustrates a block diagram of a method of feeding patch laminate sheets in accordance with embodiments of the present invention.

FIGS. 14-16 illustrate schematic side views of feeding patch laminate sheets in accordance with embodiments of the present invention.

FIG. 17 a transport mechanism for detaching plurality patch laminate sheets that are adjoined in accordance with embodiments of the present invention.

FIG. 18 illustrates a block diagram of a method for forming identification cards in accordance with embodiments of the present invention.

FIGS. 19-21 illustrate schematic sectional view of an intersecting junction portion for forming an identification card in accordance with embodiments of the present invention.

### DETAILED DESCRIPTION OF THE PREFERRED EMBODIMENTS

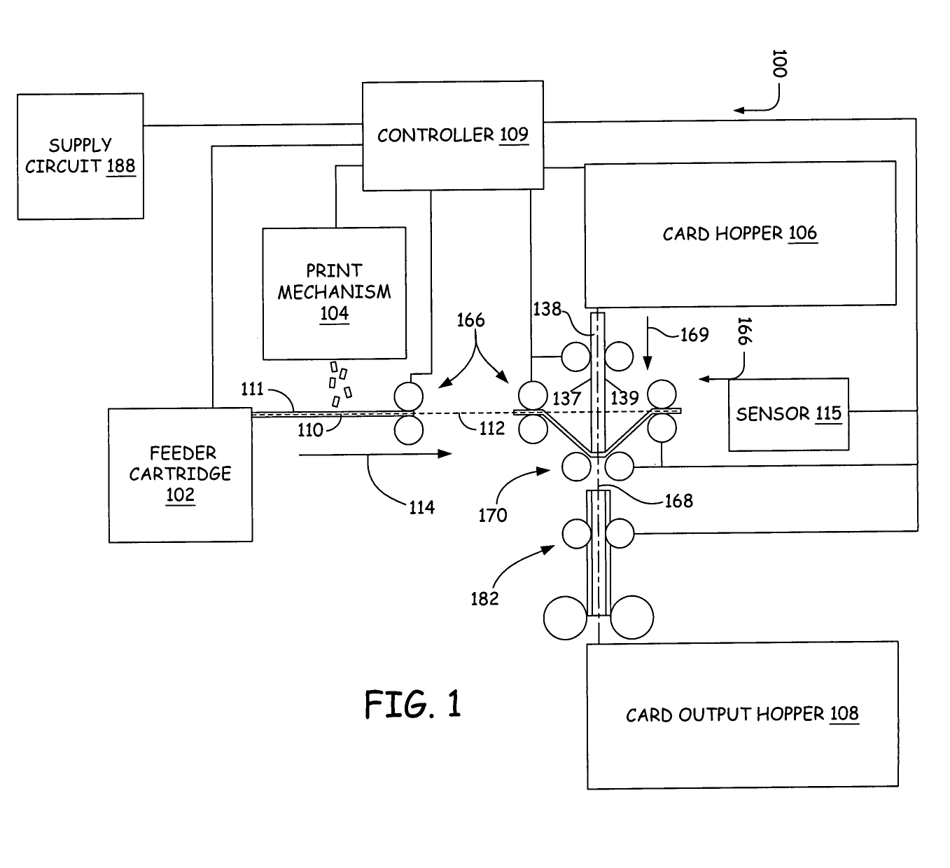

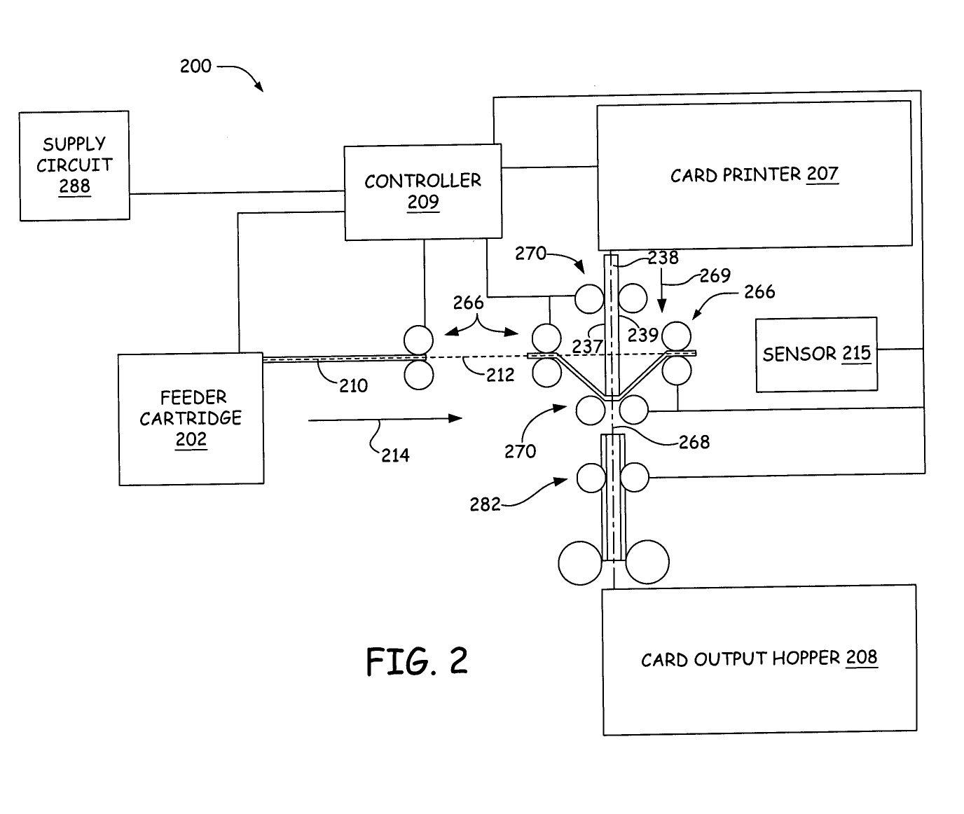

FIGS. 1 and 2 illustrate schematic diagrams of devices 100 and 200 for forming identification cards in accordance with embodiments of the present invention. Device 100 includes a feeder cartridge 102, a print mechanism 104, a card hopper 106, card output hopper 108 and a controller 109. Controller 109 is configured to manage the operation of the components in FIG. 1. Device 200 includes a feeder cartridge 202, a card printer 207, a card output hopper 208 and a controller 209. Controller 209 is configured to manage the operation of the components in FIG. 2.

In FIG. 1, feeder cartridge 102 is operably configured to feed a patch laminate 110 along a patch laminate path 112 in a direction 114. Print mechanism 104 is positioned adjacent patch laminate path 112 and is operably configured to print an image on a surface 111 of patch laminate 110. In one embodiment of the present invention, print mechanism 104 prints a reverse image on surface 111 of patch laminate 110.

In FIG. 2, feeder cartridge 202 is operably configured to feed patch laminate 210 along a patch laminate path 212 in a direction 214. Before describing the embodiments illustrated in FIGS. 1 and 2 in more detail, embodiments relating to the structure of patch laminate 110 and 210 and feeder cartridges 102 and 202 in devices 100 and 200 should be described.

The Patch Laminate

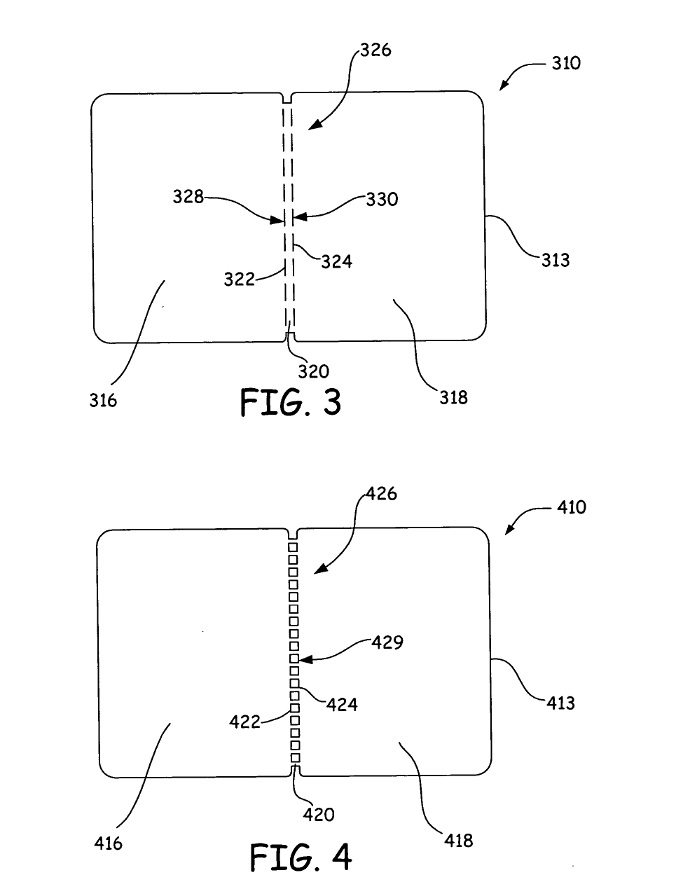

FIG. 3 illustrates a top view of a patch laminate 310 in accordance with an embodiment of the present invention. Patch laminate 310 can be used in conjunction with the devices illustrated in FIGS. 1 and 2. Patch laminate 310 is a sheet 313 of patch laminate that includes a first laminate portion 316 and a second laminate portion 318. First portion 316 can have a shape that conforms to a first face of a card substrate, such as a first face 137 of a card substrate 138 as illustrated in FIG. 1. Second laminate portion 318 can have a shape that conforms to a second face of a card substrate, such as a second face 139 of card substrate 138 as illustrated in FIG. 1. Although FIG. 3 illustrates first laminate portion 316 and second laminate portion 318 as being sized to cover the entire surface area of first face 137 and second face 139, those skilled in the art should recognize that the first and the second laminate portions can also be sized to cover an area that is less than the surface area of the first and second faces of a card substrate.

Patch laminate sheet 313 has a middle portion that connects first laminate portion 316 to second laminate portion 318. In FIG. 3, the middle portion is illustrated as bridge portion 320. Although bridge portion 320 connects first laminate portion 316 to second laminate portion 318 that are equally sized, those skilled in the art should recognize that the middle portion can connect a first laminate portion to a second laminate portion that are differently sized. Therefore, instead of the middle portion extending across the center of sheet 313 as illustrated in FIG. 3, the middle portion can extend across the sheet at a position offset from center.

In FIG. 3, bridge portion 320 includes a first edge 322 and a second edge 324 that are displaced from each other by a distance that substantially corresponds to a thickness of a card substrate. For example, the distance can be greater than 20 mils. In particular, the distance can be between 28 and 30 mils. First edge 322 connects bridge portion 320 to first laminate portion 316. Second edge 324 connects bridge portion 320 to second laminate portion 318.

Bridge portion 320 includes a plurality of spaced apart perforations 326. Each perforation of perforations 326 has a length that is approximately 200 mils. In one embodiment of the present invention, FIG. 3 illustrates that patch laminate 310 includes a first set of perforations 328 that extend along first edge 322 and a second set of perforations 330 that extend along second edge 324. The first set of perforations 328 and the second set of perforations are substantially parallel to each other. Each perforation of the first and second sets of perforations 328 and 330 are displaced from each other by a section of bridge portion 320.

In an alternative embodiment, FIG. 4 illustrates a top view of a sheet 413 of patch laminate 410 having a similar configuration as FIG. 3 and including a first laminate portion 416, a second laminate portion 418 and a bridge portion 420. Bridge portion 420 includes a plurality of perforations 426 that include a single set of perforations 429. The single set of perforations 429 extend between a first edge 422 and a second edge 424 of the bridge portion. First edge 422 and second edge 424 are displaced from each other by a distance that substantially corresponds to a thickness of a card substrate. Each perforation of the single set of perforations 429 is displaced from each other by a section of bridge portion 420. In FIG. 4, each perforation is substantially square and has a width that is approximately equal to a distance from first edge 422 to second edge 424. For example, the width of each substantially square perforation 429 and a distance from first edge 422 to second edge 424 is greater than 20 mils. In particular, the width and the distance are between about 28 and 30 mils.

In either of the above-described embodiments illustrated in FIGS. 3 and 4, those skilled in the art will recognize that first laminate portion 316, 416 and second laminate portion 318, 418 are connected to bridge portion 320, 420 in a manner that corresponds with a lengthwise edge of a card substrate. However, it should be understood that first laminate portion 316, 416 and second laminate portion 318, 418 can also be connected to bridge portions 320, 420 in a manner that corresponds with a widthwise edge of a card substrate.

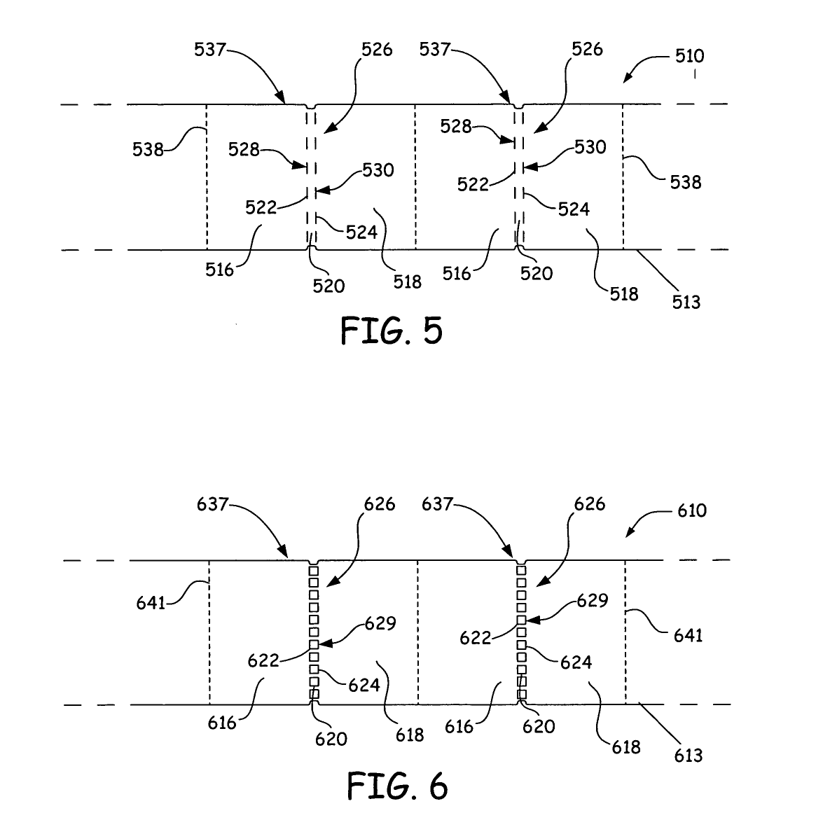

FIG. 5 illustrates a top plan view of a patch laminate 510 in accordance with an embodiment of the present invention. Patch laminate 510 can be used in conjunction with the devices illustrated in FIGS. 1 and 2. Patch laminate 510 is a roll 513 of patch laminate. The roll 513 of patch laminate 510 includes a plurality of patch laminate sheets 537 that are coupled to each other at a line of perforation 538. Each patch laminate sheet 537 includes a first laminate portion 516 and a second laminate portion 518. First laminate portion 516 can have a shape that conforms to a first face of a card substrate, such as first face 137 of card substrate 138 illustrated in FIG. 1. Second laminate portion 518 can have a shape that conforms to a second face of a card substrate, such as second face 139 of card substrate 138 as illustrated in FIG. 1. Although FIG. 5 illustrates first laminate portion 516 and second laminate portion 518 as being sized to cover the entire surface area of first face 137 and second face 139, those skilled in the art should recognize that the first and the second laminate portions can be sized to cover an area that is less than the surface area of the first and second faces of a card substrate.

Each patch laminate sheet 537 of patch laminate roll 513 has a middle portion that connects first laminate portion 516 to second laminate portion 518. In FIG. 5, the middle portion is illustrated as bridge portion 520. Although bridge portion 520 connects first laminate portion 516 to second laminate portion 518 that are equally sized, those skilled in the art should recognize that the middle portion can connect a first laminate portion to a second laminate portion that are differently sized. Therefore, instead of the middle portion extending across the center of each sheet 537 as illustrated in FIG. 5, the middle portion can extend across each sheet at a position offset from center.

In FIG. 5, bridge portion 520 includes a first edge 522 and a second edge 524 that are displaced from each other by a distance that substantially corresponds to a thickness of a card substrate. For example, the distance can be greater than 20 mils. In particular, the distance can be between approximately 28 and 30 mils. First edge 522 connects bridge portion 520 to first laminate portion 516. Second edge 524 connects bridge portion 520 to second laminate portion 518.

Bridge portion 520 includes a plurality of spaced apart perforations 526. Each perforation of perforations 526 has a length that is approximately 200 mils. In one embodiment of the present invention, FIG. 5 illustrates that perforations 526 of each patch laminate sheet 537 includes a first set of perforations 528 that extend along first edge 522 and a second set of perforations 530 that extend along second edge 524. Each perforation of the first and second sets of perforations 528 and 530 are displaced from each other by a section of bridge portion 520.

In an alternative embodiment, FIG. 6 illustrates a top plan view of a roll 613 of patch laminate 610. The roll of patch laminate includes a plurality of patch laminate sheets 637 that are coupled to each other at a line of perforation 638. Each patch laminate sheet 637 has a similar configuration to patch laminate sheet 537 in FIG. 5 and includes a first laminate portion 616, a second laminate portion 618 and a bridge portion 620. First laminate portion 616 connects to bridge portion 620 at a first edge 622 and second laminate portion 618 connects to bridge portion 620 at a second edge 624.

First edge 622 and second edge 624 are displaced from each other by a distance that substantially corresponds to a thickness of a card substrate. For example, the distance can be greater than 20 mils. In particular, the distance can be between 28 and 30 mils. The roll 613 of patch laminate 610 has a plurality of perforations 626 that include a single set of perforations 629 that extend between first edge 622 and second edge 624. Each perforation of the single set of perforations 629 are displaced from each other by a section of bridge portion 620 and have a length that is approximately 200 mils. In FIG. 6, each perforation is substantially square and has a width that is approximately equal to the distance between first edge 622 and second edge 624.

In either of the above-described embodiments illustrated in FIGS. 5 and 6, those skilled in the art will recognize that first laminate portion 516, 616 and second laminate portion 518, 618 are connected to bridge portion 520, 620 in a manner that corresponds with a lengthwise edge of a card substrate. However, it should be understood that that first laminate portion 516, 616 and second laminate portion 518, 618 are connected to bridge portion 520, 620 in a manner that corresponds with a widthwise edge of a card substrate.

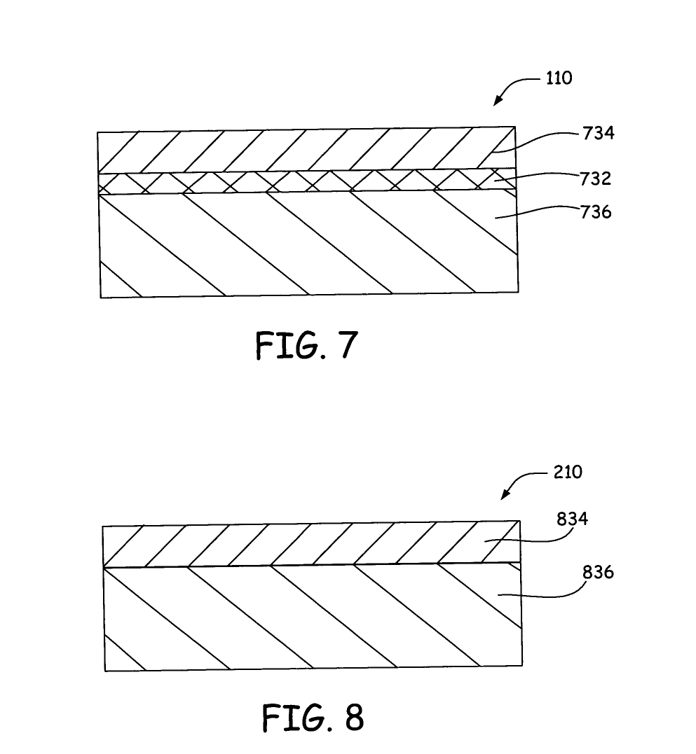

FIG. 7 illustrates a sectional view of patch laminate 110 illustrated in FIG. 1 in accordance with an embodiment of the present invention. Patch laminate 110 can have a configuration similar to patch laminate 310, 410, 510 or 610 as illustrated in FIGS. 3, 4, 5 or 6. Patch laminate 110 includes a layer of ink receptive material 732 sandwiched between a layer of adhesive 734 and a polyester layer 736.

Ink-receptive material 732 generally contains inorganic ceramic materials and organic components. The principal ceramic component of ink-receptive material 732 can be the boehmite form of alumina hydrate (Al₂O₃). Material 732 is formed using an alumina sol to which a starch or PVA has been added to at a 5-50% weight percent (typically 10%) level based on alumina hydrate solids. Ink-receptive material 732 has an average pore radius in the range of 5-20 nanometers, with pore volumes in the range of 0.3-1.0 ml/gram.

The organic portion of material 732 acts as a binder. It should be noted that the binder can be made of many types of materials. For example, the binder can be made of a styrene-butadiene copolymer rubber (NBR) latex, carboxymethyl cellulose, hydroxymethyl cellulose or polyvinyl pyrrolidone. Ink-receptive material 732 is applied to polyester layer 734. Besides layer 734 being of polyester, layer 734 can also include polymeric films and polyester resin, such as PET, polyester diacetate polycarbonate resins, fluroresisns (i.e. ETFE) and polyvinyl chloride resins, paper sheets and synthetic paper sheets.

Ink-receptive material 732 can also contain other materials to provide weather resistance, provide improved light and ozone resistance, assist in the stability of dyes and prevent dye fading. For example, additional polymerizable binders can be used to improve weather resistance, additional magnesium (Mg) and/or thiocyancate (SCN) ions can provide improved light and ozone resistance, additional organic materials such as dithiocarbamates, thiurams, thiocyanate esters, thiocyanates and hindered amines help prevent dye fading and additional non-ionic or cationic water insoluble resins particles can improve coating stability.

Other materials can be added to material 732. For example, a silica gel coating can be applied to improve gloss and abrasion resistance and silica agglomerates can be used to promote receptivity for pigmented inks.

Suitable ink-receptive materials are produced by Ikonics Corporation of Duluth, Minn., such as AccuArt™ and AccuBlack™, which are generally used for the production of film positives, negatives, color proofs and full-color presentation transparency displays. The ink-receptive coating of AccuArt™ includes many of the desired features and components for ink-receptive material 732. Although the AccuArt™ coating is a suitable material for the present invention, those skilled in the art should recognize that other ink-receptive coatings can be applied to polyester layer 734.

When print mechanism 104 (FIG. 1) prints an image on patch laminate 110, the image is printed through the layer of adhesive 734 and onto the ink receptive coating 732. The layer of adhesive 734 comprises a thermal adhesive. The combined layer of adhesive 734 and the ink receptive material 732 has a thickness between about 0.01 mil and 1 mil. The layer of polyester 736 has a thickness between about 1 mil and 2 mils. For example, a thickness of adhesive 734 and ink receptive coating 732 can be 0.5 mil and a thickness of polyester can be 1.5 mil. In this example, the total thickness of patch laminate 110 is 2.0 mils.

FIG. 8 illustrates a sectional view of patch laminate 210 illustrated in FIG. 2 in accordance with an embodiment of the present invention. Patch laminate 210 can have a configuration similar to patch laminate 310, 410, 510 or 610 as illustrated in FIGS. 3, 4, 5 or 6. Patch laminate 210 includes a layer of adhesive 834 coupled to a polyester layer 836. The layer of adhesive 834 comprises a thermal adhesive. Besides polyester layer 834 comprising polyester, polyester layer 834 can also include polymeric films and polyester resin, such as PET, polyester diacetate polycarbonate resins, fluroresisns (i.e. ETFE) and polyvinyl chloride resins, paper sheets and synthetic paper sheets. The layer of adhesive 834 has a thickness between about 0.01 mil and 1 mil. The layer of polyester 836 has a thickness between about 1 mil and 2 mils. For example, a thickness of adhesive 834 can be 0.5 mil and a thickness of polyester 836 can be 1.5 mil. In this example, the total thickness of patch laminate 210 is 2.0 mils.

The Feeder Cartridge

A need exists to improve the feeding of flexible thin films to be attached to an identification card. For example, flexible thin films that are fed from a stack of thin films tend to stick to each other due to frictional and static forces. It is desirable to develop improved feeders that overcome and eliminate these tendencies to multiple feed or mis-feed.

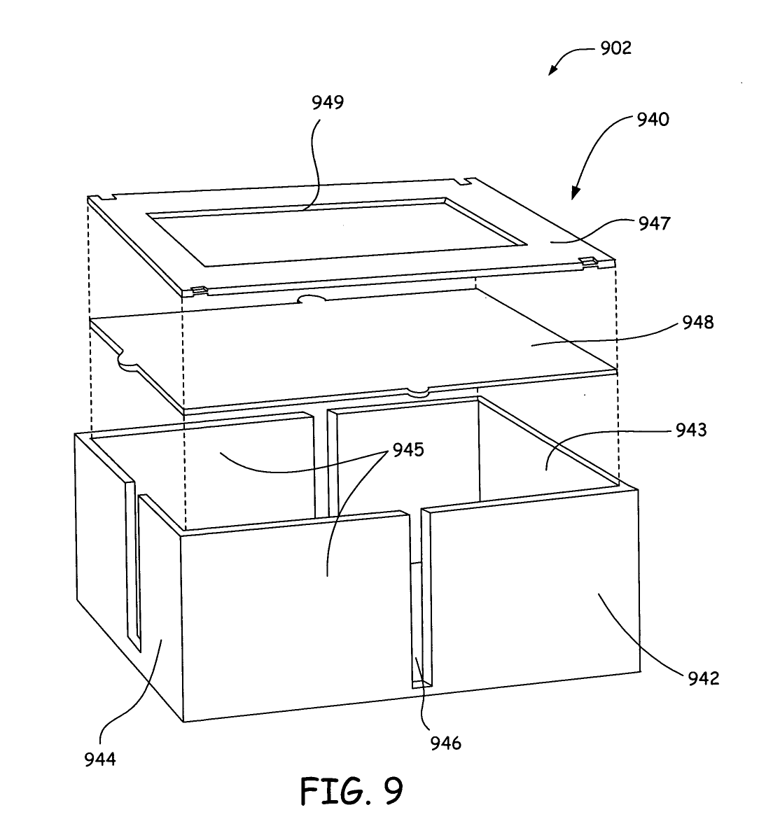

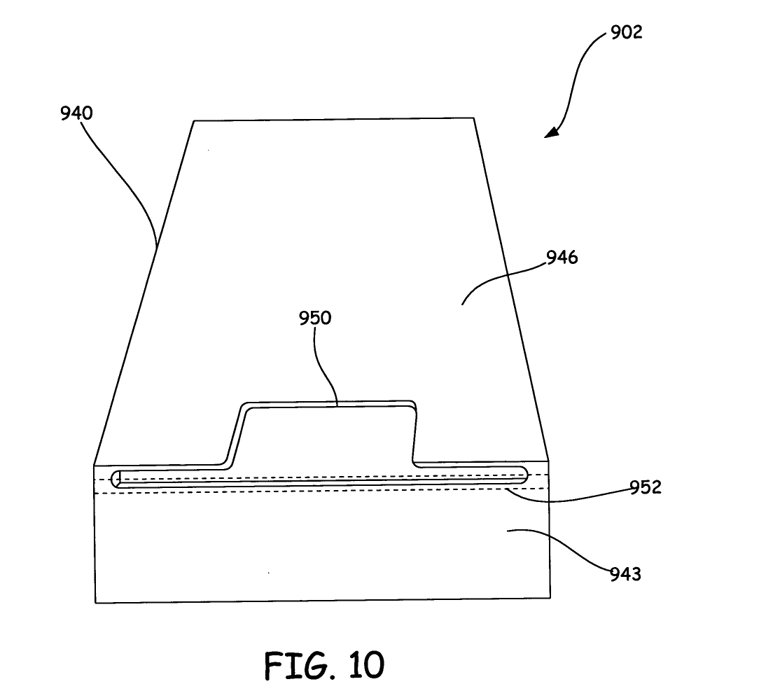

FIG. 9 is an exploded perspective view of a patch laminate feeder cartridge 902 in accordance with an embodiment of the present invention. Feeder cartridge 902 can be used in conjunction with the device illustrated in FIGS. 1 and 2. Feeder cartridge 902 includes a housing 940 having an interior cavity configured to accommodate a stack of patch laminate sheets, such as the patch laminate sheets illustrated in FIGS. 3 and 4. Housing 940 includes a top portion 942 that includes a front wall 943, a back wall 944, opposing side walls 945 and a top cover 946. Top cover 946 includes a first opening (illustrated in FIG. 10) sized to accommodate a feed roller. Housing 940 also includes a bottom cover 947 and contains a platform 948 for supporting the stack of patch laminate sheets. Bottom cover 947 includes a second opening 949 sized to accommodate a biasing mechanism. Platform 948 is not constrained and is slidable between top cover 946 and bottom cover 947 within housing 940.

FIG. 10 illustrates a top perspective view of feeder cartridge 902 in accordance with an embodiment of the present invention. As discussed above and as illustrated, top cover 946 of housing 940 includes a first opening 950 sized to accommodate a feed roller. In addition, front wall 943 includes a gap 951 sized to allow a patch laminate sheet to feed out of feeder cartridge 902 to a patch laminate path. As illustrated in dashed lines, housing 940 can also include an adapter 952 for reducing a size of gap 951. For example, adapter 952 can comprise rubber.

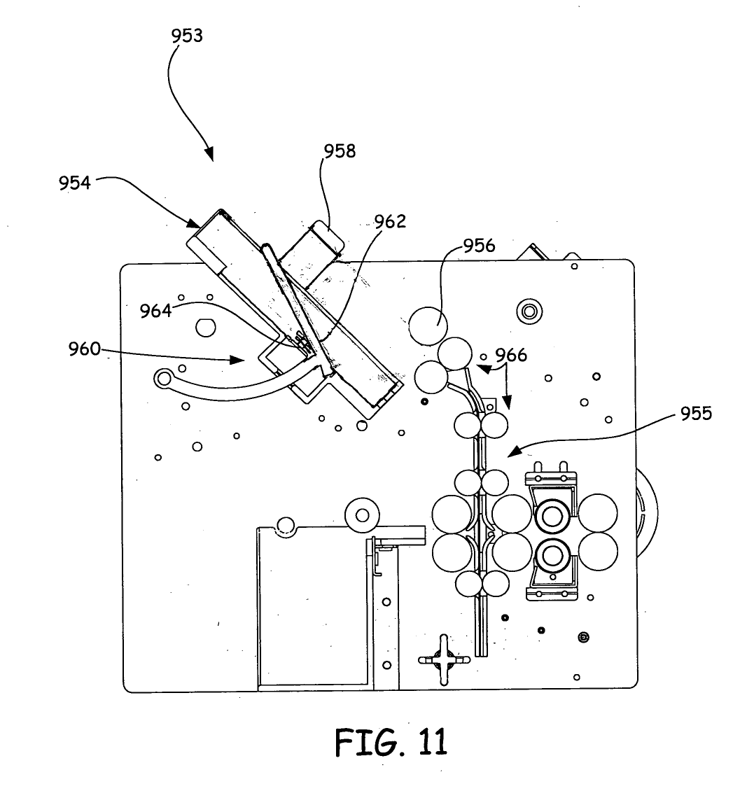

FIG. 11 illustrates a side view of a feeder cartridge portion 953 and also illustrates an intersecting junction portion 955 in accordance with an embodiment of the present invention. Intersecting junction portion 955 is described in detail with respect to FIGS. 19-21. In FIG. 11, feeder cartridge portion 953 includes a feeder cartridge receiver 954 configured to receive a feeder cartridge (not illustrated in FIG. 11). Feeder cartridge portion 953 also includes a feeder roller 956 configured to feed patch laminate sheets from feeder cartridge to a patch laminate transport mechanism 966.

Feeder cartridge receiver 954 includes a pair of holders 958 for retaining and securing a feeder cartridge in place. In addition, feeder cartridge receiver 954 includes a biasing mechanism 960. Biasing mechanism 960 is sized to fit through a second opening (not illustrated in FIG. 11) of a feeder cartridge. Biasing mechanism 960 includes a ramp 962 coupled to a loaded spring 964. However, those skilled in the art should recognize that spring 964 can be other mechanisms that create a biasing force.

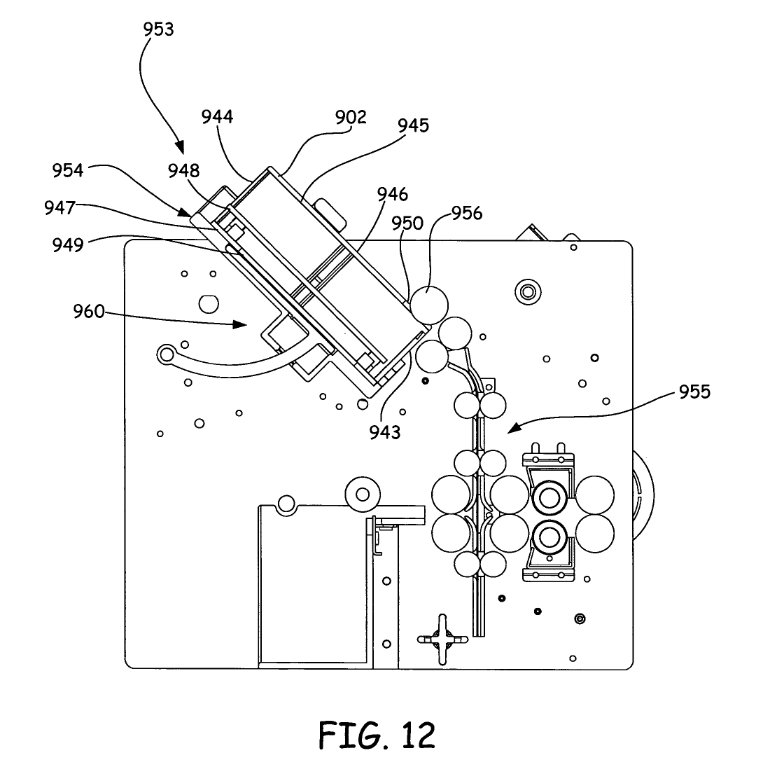

FIG. 12 illustrates a side view of a feeder cartridge portion 953 and also illustrates an intersecting junction portion 955 in accordance with an embodiment of the present invention. Intersecting junction portion 955 is described in detail with respect to FIGS. 19-21. FIG. 12 illustrates a feeder cartridge 902 secured and placed in feeder cartridge receiver 954. Feeder cartridge 902 includes front wall 943, back wall 944, opposing side walls 945 and top cover 946. Top cover 946 includes a first opening sized to accommodate feed roller 956. Feeder cartridge 902 also includes a bottom cover 947 and contains a platform 948 for supporting a stack of patch laminate sheets. Bottom cover 947 includes a second opening 949 sized to accommodate a biasing mechanism. Biasing mechanism 960 fits through second opening 949 of bottom cover 947.

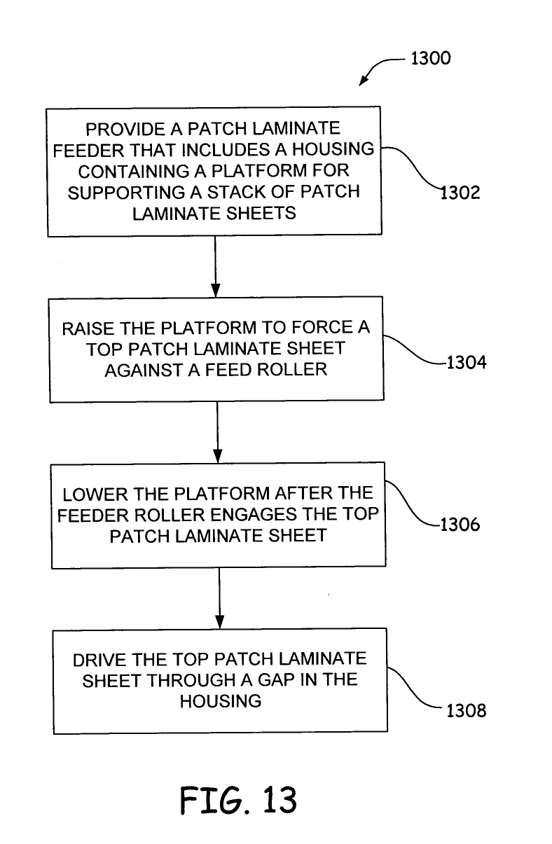

FIG. 13 is a block diagram 1300 illustrating a method of feeding a patch laminate sheet using the feeder cartridge illustrated in FIGS. 9-12. In block 1302, a patch laminate feeder is provided. The patch laminate feeder includes a housing containing a platform for supporting a stack of patch laminate sheets and a feed roller. At block 1304, the platform is raised to force a top patch laminate sheet against the feeder roller. At block 1306, the platform is lowered after the feeder roller engages the top patch laminate sheet. At block 1308, the top patch laminate is driven through a gap in the housing after the platform is lowered.

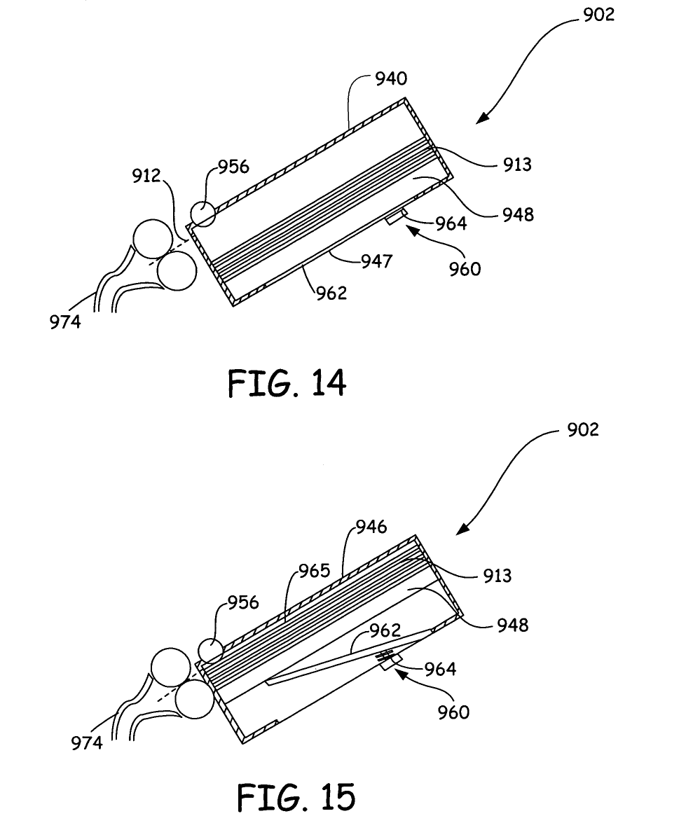

FIGS. 14-16 schematically illustrate sectional views of feeder cartridge 902 while the feeder cartridge is secured in a feeder cartridge receiver 954 (illustrated in FIGS. 11 and 12) in accordance with an embodiment of the present invention. In addition, FIGS. 14-16 graphically illustrate the steps associated with feeding a patch laminate sheet to a patch laminate path 912 as illustrated in FIG. 13. In FIG. 14, housing 940 of feeder cartridge 902 is loaded with a stack of patch laminate sheets 913. For example, each patch laminate sheet can be patch laminate sheet 313 or 413 illustrated in FIGS. 3 and 4. The stack of patch laminate sheets 913 are loaded onto platform 948 such that the platform is situated between bottom cover 947 of feeder cartridge 902 and the stack of patch laminate sheets 913. As illustrated in FIG. 14, the stack of patch laminate sheets are in a loaded position and, therefore, biasing mechanism 960 is configured into a non-actuated position. In a non-actuated positioned, loaded spring 964 is compressed such that ramp 962 is in alignment with bottom cover 947 and the stack of patch laminate sheets 913 are spaced from feed roller 956.

Upon receiving a signal from a controller, such as controller 109 illustrated in FIG. 1, to feed a patch laminate sheet, the stack of patch laminate sheets 913 are configured into a feed position as illustrated in FIG. 15. In a feed position, spring 964 is deployed or released from compression and ramp 962 raises platform 948 and the stack of patch laminate sheets 913 toward top cover 946 and feed roller 956. In the feed position, feed roller 956 is configured to rotate and engage top laminate sheet 965 of the stack of patch laminate sheets 913. In one embodiment of the present invention feed roller 956 comprises a surface having friction. For example, the surface of feed roller 956 can be tacky.

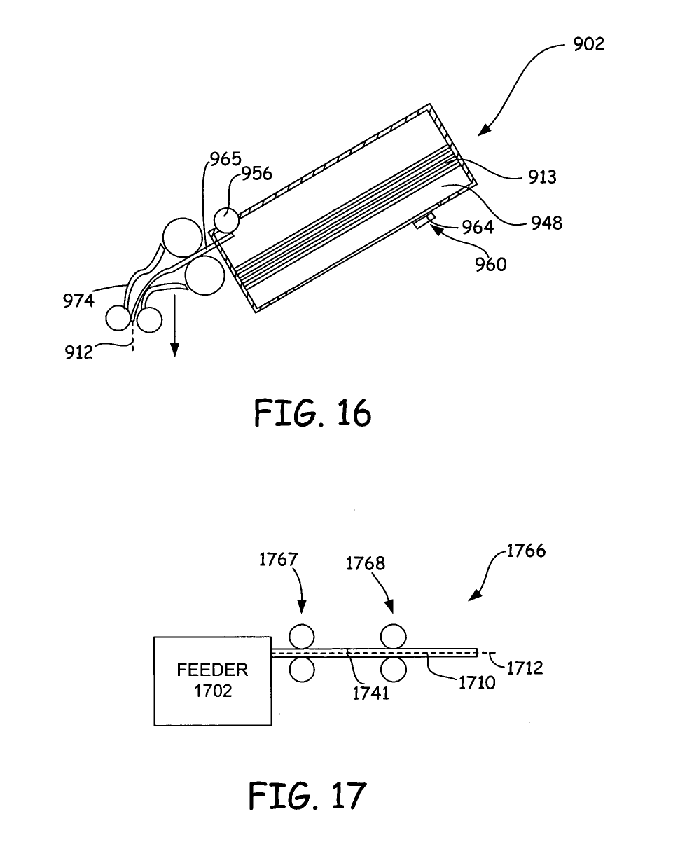

Upon engaging the top sheet of the stack of patch laminate 913, the controller instructs biasing mechanism 960 to compress or return to the loaded position as illustrated in FIG. 16. By returning biasing mechanism 960 to the loaded position, the biasing mechanism lowers platform 948 and the stack of patch laminate 913 away from feed roller 956 such that only top sheet 965 is fed to patch laminate path 912. This prevents the remaining patch laminate sheets from also feeding with top sheet 965. As top laminate sheet 965 is being fed, the top laminate sheet is guided towards the patch laminate transport mechanism by a guide 974.

Referring back to FIG. 1, feeder cartridge 102 is configured to feed patch laminate 110 to patch laminate path 112. In one embodiment, feeder cartridge 102 feeds patch laminate sheets, such as patch laminate sheet 313 and 413 of FIGS. 3 and 4, to patch laminate path 112 in accordance with feeder cartridge 902 illustrated in FIGS. 9-16. In another embodiment, feeder cartridge 102 feeds a roll of patch laminate or a plurality of adjoining patch laminate sheets, such as patch laminate 510 and 610 of FIGS. 5 and 6, to patch laminate path 112. Each of the plurality of patch laminate sheets are adjoined to each other by a line of perforation, such as perforation line 538 and 638 of FIGS. 5 and 6. In the latter embodiment, device 100 is equipped with a mechanism for separating each adjoining patch laminate sheet from each other.

In one embodiment, and as illustrated in FIG. 17, a patch laminate mechanism 1766 includes a first set of pinch rollers 1767 and a second set of pinch rollers 1768. As illustrated in FIG. 17, feeder 1702 feeds a roll of patch laminate 1710 along patch laminate path 1712 and through each set of pinch rollers in a direction 1714. The first set of pinch rollers 1767 is operably configured to affix one sheet of patch laminate 1710 while the second set of pinch rollers 1768 is operably configured to drive the adjoining sheet of patch laminate. Therefore, each patch laminate sheet is separated from an adjoining patch laminate sheet at a line of perforation 1741. Those skilled in the art should recognize that are other methods of separating adjoining patch laminate sheets can be used.

Referring back to FIG. 1, patch laminate 110 is transported along patch laminate path 112 past print mechanism 104 by patch laminate transport mechanism 166 as instructed by controller 109. An example print mechanism 104 includes an ink jet print mechanism. However, other types of print mechanisms can be used. In one embodiment of the present invention, patch laminate transport mechanism 166 includes multiple sets of pinch rollers. During operation, each of the sets of pinch rollers drive patch laminate 110 in direction 114 along patch laminate path 112.

Card hopper 106 is configured to hold a plurality of card substrates 138 and is operably configured to feed each card substrate 138 to a card path 168 in a direction 169 as instructed by controller 109. Card path 168 is substantially perpendicular to patch laminate path 112. A card transport mechanism 170 is operably configured to transport each card substrate 138 along card path 168 as instructed by controller 109. In one embodiment of the present invention, card transport mechanism 170 includes multiple sets of pinch rollers. Each of the sets of pinch rollers drives a card substrate 138 in direction 169 along card path 168.

Device 100 also includes a sensor 115. Sensor 115 is configured to sense the position of patch laminate 110 with respect to card substrate 138. Sensor 115 assists controller 109 in aligning patch laminate 110 to card substrate 138 such that an identification card can be formed. In one embodiment of the present invention, sensor 115 is a slotted optical sensor. In another embodiment of the present invention, sensor 115 is an interrupt sensor having a mechanical arm. However, those skilled in the art should recognize that other types of sensors can be used.

Referring back to FIG. 2, feeder cartridge 202 is configured to feed patch laminate 210 to patch laminate path 212. As discussed with reference to FIG. 1, feeder cartridge 202 is configured to feed patch laminate sheets, such as patch laminate 310 and 410 of FIGS. 3 and 4, to patch laminate path 112 in accordance with feeder cartridge 902 illustrated in FIGS. 9-15. In another embodiment, feeder cartridge 102 feeds a roll of patch laminate or a plurality of adjoining patch laminate sheets, such as patch laminate 510 and 610 of FIGS. 5 and 6, to patch laminate path 212 in accordance with the embodiment illustrated in FIG. 17. Patch laminate 210 is transported along patch laminate path 212 as instructed by controller 109. Patch laminate transport mechanism 266 includes multiple sets of pinch rollers. During operation, each of the sets of pinch rollers drives patch laminate 210 in direction 214 along patch laminate path 212.

Card printer 207 is configured to print an image on a first card face 237 and/or a second card face 239 of card substrate 238. In addition, card printer 207 is operably configured to feed each card substrate to a card path 268 in a direction 269 as instructed by controller 209. Card path 268 is substantially perpendicular to patch laminate path 212. A card transport mechanism 270 is operably configured to transport each card substrate 238 along card path 268 as instructed by controller 209. In one embodiment of the present invention, card transport mechanism 270 includes multiple sets of pinch rollers. Each of the sets of pinch rollers drives a card substrate 238 in direction 269 along card path 268.

Device 200 also includes a sensor 215 similar to sensor 115 of FIG. 1. Sensor 215 is configured to sense the position of patch laminate 210 with respect to card substrate 238. Sensor 215 assists controller 209 in determining instructions for patch laminate mechanism 266 in align patch laminate 210 to card substrate 238 such that an identification card can be formed.

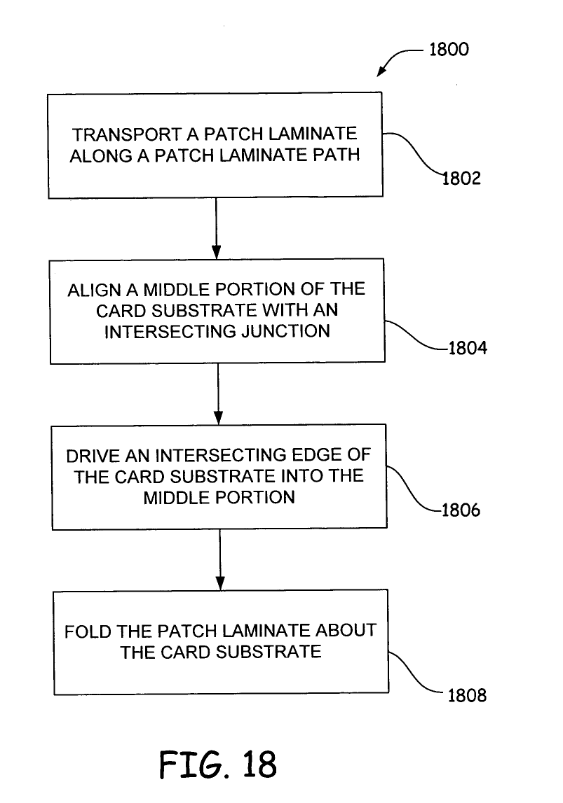

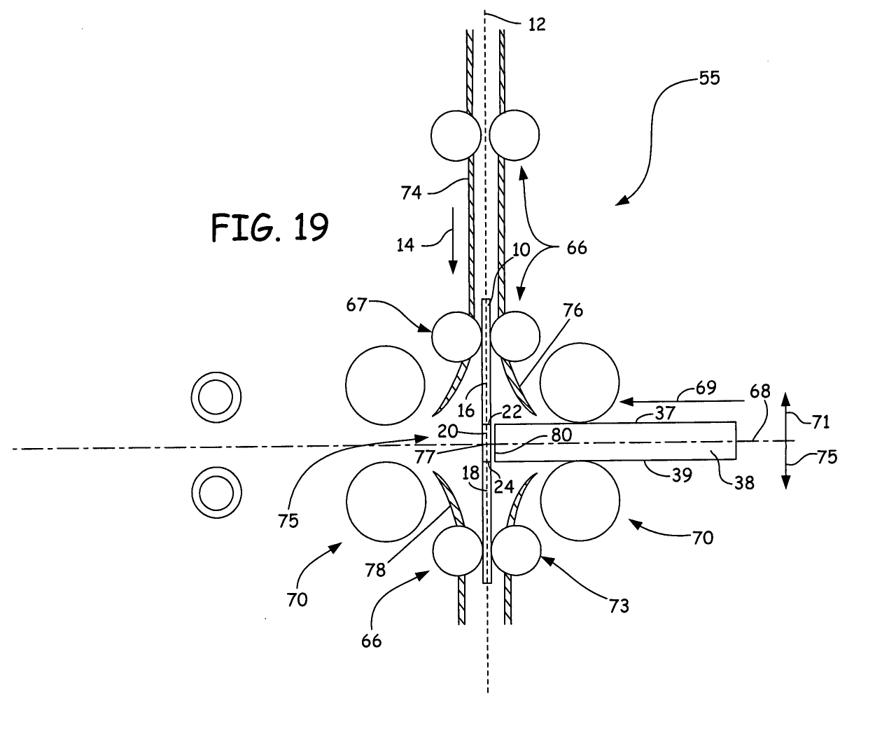

FIG. 18 is a block diagram 1800 illustrating a method of forming an identification card in accordance with an embodiment of the present invention. At block 1802, a patch laminate is transported along a patch laminate path to an intersection junction of the patch laminate path and a card path. The patch laminate path is substantially perpendicular to the card path. At block 1804, a middle portion of the patch laminate is aligned with the intersection junction. At block 1806, an intersecting edge of the card substrate is driven along the card path and into the middle portion of the card substrate. At block 1808, the patch laminate is folded about the card substrate such that a first laminate portion overlays a first face of the card substrate and a second laminate portion overlays a second face of the card substrate, which is opposite the first face. The following description, in association with FIGS. 19-21, is a detailed description of the method illustrated in FIG. 18 using devices 100 and 200.

Forming an Identification Card

FIGS. 19-21 illustrate schematic sectional views of an intersecting junction portion 55 for forming an identification card in accordance with an embodiment of the present invention. The intersecting junction portion 55 illustrated in FIGS. 19-21 can be used in conjunction with devices 100 and 200. When the process is used in conjunction with device 100, an image is printed to the patch laminate and then laminated to a card substrate to form a dual-sided image identification card. When the process is used in conjunction with device 200, an image is printed to a card substrate and then laminated with a patch laminate to form a dual-sided image identification card. However, those skilled in the art should recognize that a single-sided image identification card could also be formed.

In FIG. 19, a patch laminate 10 is transported by a patch laminate transport mechanism 66 along a patch laminate path 12 in a direction 14. A guide 74 surrounds patch laminate path 12. Guide 74 is configured to constrain patch laminate 10 to patch laminate path 12. A card substrate 38 is transported by a card transport mechanism 70 along a card path 68 in a direction 69. Guide 74 includes an opening 75 configured to allow the card substrate 38 to substantially intersect with patch laminate path 12 at an intersecting junction 77. The point where card path 68 intersects with patch laminate path 12 is intersecting junction 77. In addition, opening 75 includes arcuate lead-in edges 76 and arcuate lead-out edges 78. Opening 75 has a width that is greater than the thickness of card substrate 38.

Patch laminate 10 can be a patch laminate such as those illustrated in FIGS. 3, 4, 5 and 6. Patch laminate 10 includes a first laminate portion 16 having a shape that conforms to a first face 37 of card substrate 38 and a second laminate portion 18 having a shape that conforms to a second face 39 of the card substrate. Patch laminate 10 also includes a middle portion or bridge portion 20 that includes a first edge 22 and a second edge 24. First edge 22 is configured to couple bridge portion 20 to first portion 16. Second edge 24 is configured to couple bridge portion 20 to second portion 18. Bridge portion 20 is considered to be the center of patch laminate 10 and includes a plurality of perforations such that first laminate portion 16 and second laminate portion 18 can fold about card substrate 38. Card substrate 38 includes a leading edge or intersecting edge 80.

A sensor, such as sensor 115 or 215 of FIG. 1 or 2, is configured to sense the position of patch laminate 10 with respect to intersecting junction 77 and relay positional information to a controller, such as controller 109 or 209 of FIG. 1 or 2. The sensor assists the controller in aligning bridge portion 20 with intersecting edge 80 of card substrate 38. Patch laminate transport mechanism 66 includes a first component 67 configured to support first laminate portion 16 on a first side 71 of card path 68. Patch laminate transport mechanism 66 includes a second component 73 configured to support second laminate portion 18 on a second side 75 of card path 68.

Although not clearly illustrated in FIGS. 19-21, after patch laminate transport mechanism 66 has aligned bridge portion 20 with intersecting edge 80 of card substrate 38, the controller instructs first component 67 and second component 73 of the patch laminate transport mechanism to create a small amount of slack in patch laminate 10. Creating slack in patch laminate 10 results in the patch laminate slightly bending at bridge portion 20 such that card substrate 38 does not break through the center or the bridge portion of the patch laminate. However, the amount of slack should be optimized. Too much slack will cause bridge portion 20 to become unaligned. Too little slack can potentially result in card substrate 38 breaking bridge portion 20.

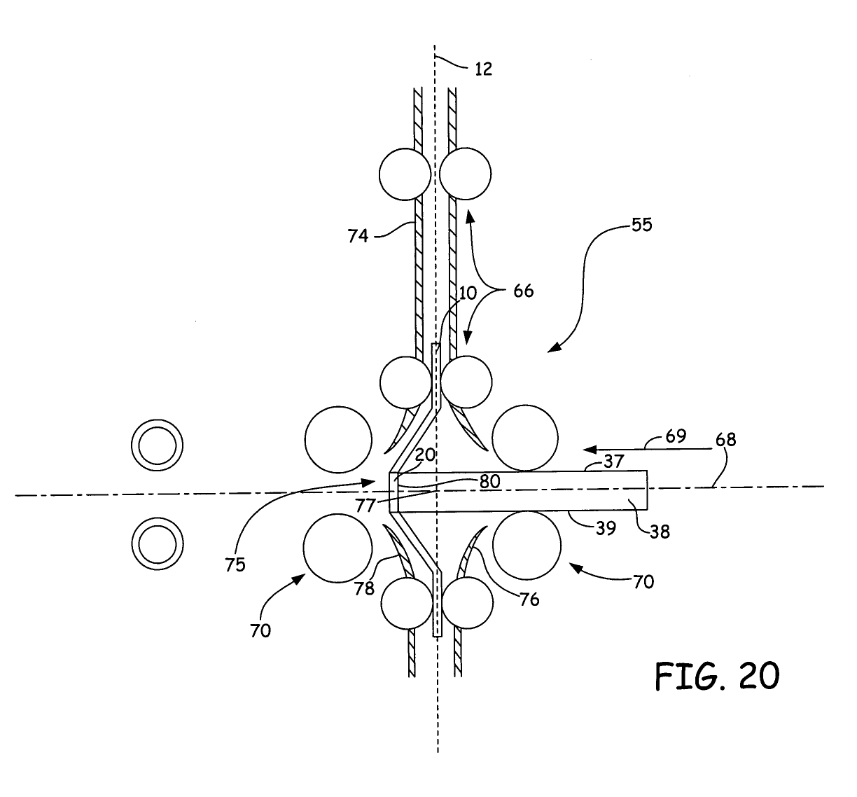

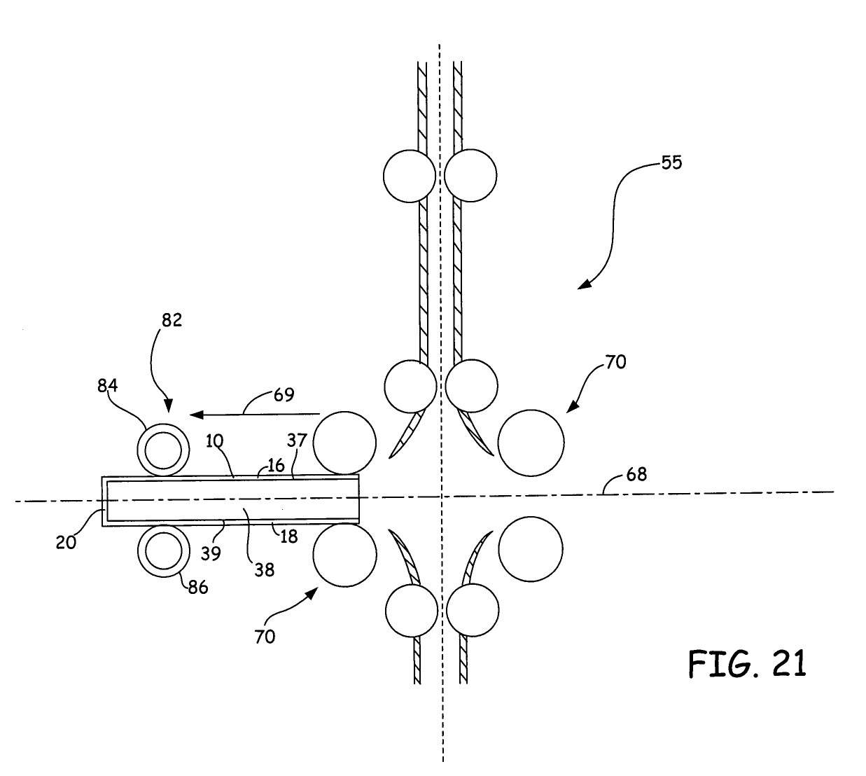

In FIG. 20, card transport mechanism 70 continues to transport card substrate 38 along card path 68. Upon driving card substrate 38, intersecting edge 80 comes into contact with the center or bridge portion 20 of patch laminate 10. As card substrate 38 comes into contact, patch laminate folds about the card substrate such that first laminate portion 16 overlays first face 37 of the card substrate and second laminate portion 18 overlays second face 39 of the card substrate. The folding of patch laminate about card substrate 38 remains within the constraints of the lead-in edges 76 and lead-out edges 78 of opening 75.

In FIG. 21, card transport mechanism 70 drives card substrate 38 and folded patch laminate 10 to lamination mechanism 82. Lamination mechanism 82 is operably configured to simultaneously laminate or adhere first portion 16 to first face 37 and second portion 18 to second face 39. Lamination mechanism 82 includes a first lamination roller 84 separated by a gap from a second lamination roller 86. Lamination rollers 84 and 86 are heated rollers that are controlled by the assistance of at least one temperature sensor.

Referring back to FIGS. 1 and 2 and in accordance with another embodiment of the present invention, devices 100 and 200 include a supply circuit 188 and 288. Supply circuit 188, 288 is preferably an integrated circuit that includes a memory containing supply information relating to various parameters of feeder cartridges 102 and 202, card hopper 107 and card printer 207.

The supply information can include, for example, a card supply identifier, patch laminate identifier, a card type, a patch laminate type, card dimensions and patch laminate dimensions (length, width and thickness), card and patch laminate features, card and patch laminate identifiers, card and patch laminate orientation, a card and patch laminate count, card and patch laminate supplier information (i.e. lot number), dealer information, security codes, an expiration date, printer settings, and other information.

The card type identifies a pre-defined type of card such as a CR-80, CR-90 or other standardized type of card. The card features can include such things as whether the card has a magnetic stripe, is a “smart” card, and other conventional card features. The card supply identifier allows for a check to be performed to determine whether card hopper 107 or card printer 207 include card substrates that are compatible with the patch laminate 110 or 210. The card identifiers can be a series of serial numbers that uniquely identify each card. This information can be used, for example to correlate the printed identification card with the person who formed the card. The card orientation relates to whether the cards are oriented lengthwise or widthwise with the card path. The printer settings allow either print mechanism 104 or card printer 207 to be configured for optimal performance. The card and patch laminate dealer information relates to the dealer that sold the cards and patch laminate, which may be responsible for customizing the supply information stored in the memory of supply circuit 188, 288. The card count or patch laminate count relates to the number of cards in the card stack or in the stack of patch laminate. In addition, patch laminate count relates the number of patch laminate sheets that are adjoined in a roll.

The patch laminate type identifies a pre-defined type of patch laminate such as a patch laminate sheet or patch laminate roll. The patch laminate features can include such things as whether the patch laminate has a holographic or security features. The patch laminate supply identifier allows for a check to be performed to determine whether feeder cartridge 107 or feeder cartridge 207 include patch laminate that is compatible with the card substrates. The patch laminate identifiers can be a series of serial numbers that uniquely identify each patch laminate. This information can be used, for example to correlate the printed patch laminate or laminated patch laminate with the person who formed the identification card. The patch laminate orientation relates to whether the patch laminate is oriented lengthwise or widthwise with respect to the card substrates.

The security codes can be used to prevent unauthorized use of the cards or prevent the use of card hopper 107 or card printer 207. An improper security code could, for example, trigger an interlock in device 100 and 200 to prevent the operation thereof. The expiration date can be used as a security measure to prevent the use of cards and patch laminate after a predetermined date.

In accordance with one embodiment of the invention, supply circuit 188, 288 includes radio frequency (RF) communication methods that can be implemented to provide wireless communication between supply circuit 188, 288 and controller 109, 209.

Although the present invention has been described with reference to preferred embodiments, workers skilled in the art will recognize that changes may be made in form and detail without departing from the spirit and scope of the invention.

1. A patch laminate for coupling to an identification card substrate, the patch laminate comprising:
a first laminate portion including an adhesive layer having a shape that conforms to a first face of the card substrate;
a second laminate portion including an adhesive layer having a shape that conforms to a second face of the card substrate; and
a bridge portion connecting the first laminate portion at a first edge and the second laminate portion at a second edge, wherein the first and second edges are displaced from each other by a distance substantially corresponding to a thickness of the card substrate.

2. The patch laminate of claim 1, wherein the bridge portion comprises a plurality of spaced apart perforations.

3. The patch laminate of claim 2, wherein the spaced apart perforations are displaced from each other by a section of the bridge portion.

4. The patch laminate of claim 2, wherein the plurality of spaced apart perforations comprise a first set of perforations that extends along the first edge and a second set of perforations that extends along the second edge of the bridge portion.

5. The patch laminate of claim 4, wherein the first set of perforations and the second set of perforations are substantially parallel to each other.

6. The patch laminate of claim 2, wherein the plurality of spaced apart perforations extend between the first edge and the second edge of the bridge portion.

7. The patch laminate of claim 6, wherein the plurality of spaced apart perforations are substantially square.

8. The patch laminate of claim 7, wherein the substantially square perforations comprise a width approximately equal to a distance between the first edge and the second edge.

9. The patch laminate of claim 1, wherein the first edge and the second edge are displaced from each other by the distance comprising the distance greater than 20 mils.

10. The patch laminate of claim 9, wherein the distance comprises between approximately 28 and 30 mils.

11. The patch laminate of claim 1, wherein the first portion, the second portion and the bridge portion are included on a patch laminate sheet.

12. The patch laminate of claim 11, wherein the patch laminate sheet comprises a plurality of patch laminate sheets, each patch laminate sheet of the plurality of patch laminate sheets is coupled to an adjoining patch laminate sheet along a line of perforation.

13. The patch laminate of claim 1, wherein the first laminate portion, the second laminate portion and the bridge portion further comprises a layer of polyester, wherein the layer of adhesive is coupled to the layer of polyester.

14. The patch laminate of claim 1, wherein the first laminate portion, the second laminate portion and the bridge portion further comprise an ink receptive layer and a layer of polyester, wherein the ink receptive layer is sandwiched between the layer of adhesive and the layer of polyester.

15. The patch laminate of claim 1, wherein the bridge portion is connected to the first laminate portion and the second laminate portion in a manner that corresponds to a lengthwise edge of the card.

16. The patch laminate of claim 1, wherein the bridge portion is connected to the first laminate portion and the second laminate portion in a manner that corresponds to a widthwise edge of the card.

17. A device for forming an identification card comprising:
a patch laminate transport mechanism configured to transport a patch laminate along a patch laminate path;
a card transport mechanism configured to transport a card substrate along a card path that is substantially perpendicular to the patch laminate path, wherein the patch laminate path and the card path intersect at an intersecting junction; and
a controller configured to align a middle portion of the patch laminate with the intersecting junction.

18. The device of claim 17, further comprising a print mechanism positioned adjacent the patch laminate path and configured to print an image on a surface of the patch laminate before the controller aligns the middle portion of the patch laminate to the intersecting junction.

19. The device of claim 18, wherein the print mechanism is configured to print a reverse image on the surface of the patch laminate.

20. The device of claim 17, further comprising a card printer configured to print an image on the first face and the second face of the card substrate before the card transport mechanism transports each card substrate.

21. The device of claim 17, wherein the patch laminate comprises a sheet of patch laminate.

22. The device of claim 21, further comprising a patch laminate feeder configured to feed the patch laminate sheet to the patch laminate transport mechanism, the patch laminate feeder comprising:
a housing containing a platform that supports a stack of patch laminate sheets; and
a biasing mechanism configured to raise the platform to force a top patch laminate sheet against a feed roller, wherein the biasing mechanism is further configured to lower the platform after the feed roller engages the top patch laminate sheet.

23. The device of claim 22, wherein the biasing mechanism operates through a bottom opening in the housing of the patch laminate feeder.

24. The device of claim 22, wherein the biasing mechanism comprises a spring coupled to a ramp.

25. The device of claim 17, wherein the patch laminate comprises a plurality of adjoining patch laminate sheets.

26. The device of claim 17, further comprising a guide configured to constrain the patch laminate to the patch laminate path.

27. The device of claim 26, wherein the guide surrounds the patch laminate path.

28. The device of claim 27, wherein the guide comprises an opening having arcuate lead-in edges and arcuate lead-out edges, wherein the opening is positioned at the intersecting junction of the patch laminate path and the card path.

29. The device of claim 17, further comprising a sensor configured to assist the controller in aligning the middle portion center of the patch laminate to the junction.

30. The device of claim 29, wherein the sensor comprises a slotted optical sensor.

31. The device of claim 29, wherein the sensor comprises an interrupt sensor having a mechanical arm.

32. The device of claim 17, further comprising a supply circuit having a memory containing information related to parameters of the patch laminate and the card substrate.

33. The device of claim 17, wherein the middle portion of the patch laminate comprises a plurality of perforations.

34. The device of claim 17, further comprising a lamination mechanism configured to laminate a first laminate portion of the patch laminate to a first face of the card substrate and a second laminate portion of the patch laminate to a second face of the card substrate.

35. The device of claim 34, wherein the lamination mechanism comprises a pair of lamination rollers configured to simultaneously apply heat and pressure to the first face and the second face of the card substrate.

36. The device of claim 17, wherein the patch laminate transport mechanism comprises:
a first component configured to support the first laminate portion of the patch laminate on a first side of the card path; and
a second component configured to support the second laminate portion of the patch laminate on a second side of the card path.

37. The device of claim 36, wherein the first component and second component are further configured to create slack in the patch laminate.

38. A method of forming an identification card comprising:
transporting a patch laminate along a patch laminate path to an intersecting junction of the patch laminate path and a card path, the patch laminate path is substantially perpendicular to the card path;
aligning a middle portion of the patch laminate with the intersecting junction;
driving an intersecting edge of the card substrate along the card path into the middle portion of the patch laminate at the intersecting junction; and
folding the patch laminate about the card substrate such that a first laminate portion overlays a first face of the card substrate and a second laminate portion is overlays a second face of the card substrate, which is opposite the first face.

39. The method of claim 38, further comprising printing an image to a surface of the patch laminate before aligning the middle portion of the patch laminate with the junction.

40. The method of claim 39, wherein printing an image to the surface of the patch laminate comprises printing a reverse image on the surface of the patch laminate.

41. The method of claim 38, further comprising printing an image on the first face and the second face of the card substrate before the card transport mechanism transports each card substrate.

42. The method of claim 38, further comprising guiding the patch laminate along the patch laminate path using a guide, wherein the guide includes an opening positioned at the intersecting junction.

43. The method of claim 38, wherein transporting a patch laminate comprises transporting a patch laminate sheet.

44. The method of claim 43, wherein transporting the patch laminate sheet comprises transporting a plurality of patch laminate sheets, wherein each patch laminate sheet is coupled to an adjoining patch laminate sheet at a line of perforation.

45. The method of claim 38, wherein aligning the middle portion of the patch laminate with the intersecting junction comprises creating slack in the patch laminate such that the patch laminate slightly bends at the middle portion of the patch laminate.

46. The method of claim 38, wherein folding the patch laminate about the card substrate comprises folding the patch laminate about the card substrate after the intersecting edge of the printed card substrate engages the bridge portion of the patch laminate.

47. The method of claim 38, further comprising simultaneously laminating the first laminate portion to the first face and the second laminate portion to the second face of the card substrate.

48. The method of claim 38, wherein aligning includes supporting the first laminate portion of the patch laminate on a first side of the card path and supporting the second laminate portion of the patch laminate on a second side of the card path.

49. A method of feeding patch laminate sheets comprising:
providing a patch laminate feeder including a housing containing a platform that supports a stack of patch laminate sheets and a feed roller;
raising the platform to force a top patch laminate sheet of the stack of patch laminate sheets against the feed roller; and
lowering the platform after the feeder roller engages the top patch laminate sheet; and
driving the top patch laminate sheet through a gap in the housing after the lowering of the platform.

50. The method of claim 49, further comprising providing an adapter affixed to at least a portion of the gap for reducing a thickness of the opening.

51. The method of claim 50, wherein the adapter comprises rubber.

52. The method of claim 49, wherein raising and lowering of the stack of patch laminate sheets comprises deploying a biasing mechanism and compressing a biasing mechanism.

53. The method of claim 50, wherein the biasing mechanism comprises a biasing ramp coupled to a spring.
